(19) United States
(12) Patent Application Publication
(10) Pub. No.: US 2009/0319064 A1
(43) Pub. Date: Dec. 24, 2009

(54) MULTIMEDIA PLAYER

(75) Inventor: Chi-Lun CHANG, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/145,359

(22) Filed: Jun. 24, 2008

(51) Int. Cl. G06F 17/00

(52) U.S. Cl. 700/94

(57) ABSTRACT

A multimedia player is provided. The multimedia player can be selectively operated in a first mode or a second mode, and includes a plurality of multimedia sources, a USB hub interface, and a processor. The plurality of multimedia sources provides multimedia data when the multimedia player operates in the first mode. The USB hub interface connects to an external electronic device and communicates with the external electronic device when the multimedia player operates in the second mode. The processor couples to the plurality of multimedia sources and the USB hub interface. When operated in a first mode, the processor retrieves and decodes the multimedia data, wherein the decoded multimedia data is ready for presentation. When operated in the second mode, the processor connects to the external electronic device via the USB hub interface. The multimedia sources then serve as USB devices supporting the external electronic device.

### BACKGROUND OF THE INVENTION

1. Field of the Invention

The invention relates to multimedia players, and, more particularly, to multimedia players capable of transmitting and receiving multimedia files via a universal serial bus (USB).

Because the home network is an emerging trend, new home appliances are required continually increase the number of provided functions. For example, a networked multimedia player, such as a DVD player, is an inevitable development. Network support for a conventional multimedia player is, however, a costly feature, regardless of whether it is implemented by hardware or software.

Thus, an interface provided between a networked device, such as a computer, and a multimedia player is desirable.

### BRIEF SUMMARY OF THE INVENTION

In one aspect of the invention, a multimedia player comprising a plurality of multimedia sources, a USB (universal serial bus) hub interface, and a processor is provided. The multimedia player can be selectively operated in a first mode or a second mode. The plurality of multimedia sources provides multimedia data when the multimedia player is operated in the first mode. The USB hub interface connects to an external electronic device and communicates with the external electronic device when the multimedia player operates in the second mode. The processor couples to the plurality of multimedia sources and the USB hub interface. When operated in a first mode, the processor retrieves and decodes the multimedia data, making it ready for presentation. When operated in the second mode, the processor connects to the external electronic device via the USB hub interface. The multimedia sources are then able to serve as USB devices supporting the external electronic device.

In another aspect of the invention, a multimedia player comprising a plurality of multimedia sources, a USB hub interface, and a processor is provided. The multimedia player in a first mode plays back multimedia files either from the local multimedia sources or, in a second mode, from external devices. The plurality of multimedia sources provides multimedia data when the multimedia player operates in the first mode. The processor loads multimedia data from one of the multimedia sources and decodes the multimedia data. The decoded multimedia data is then ready for presentation. The USB hub interface connects to an external electronic device. When the multimedia device operates in the second mode, the USB hub interface receives multimedia data from the external electronic device. When operated in the second mode, the processor receives multimedia data from the external electronic devices.

In yet another aspect of the invention, a multimedia player comprising a plurality of multimedia sources, a processor, and a USB hub interface, is provided. The multimedia player plays back multimedia files in a first and a third mode, or uploads multimedia data to a remote multimedia player in a second mode. The multimedia sources are devices that provide multimedia data for display by the multimedia player. The USB hub interface connects to an external electronic device. The external electronic device has a USB host processor and a network interface. The processor couples to the plurality of multimedia sources and the USB hub interface. When operated in a first mode, the processor receives multimedia data from the multimedia sources, and decodes the multimedia data, wherein the decoded multimedia data is ready for presentation. When operated in the second mode (upload mode), the processor connects to the external electronic device via the USB hub interface, and transmits multimedia data to the external electronic device. The external electronic device bypasses the multimedia data to a remote player through the network interface. In the second mode, a multimedia data can be transferred from the local multimedia player to a remote multimedia player. When operated in the third mode (download mode), the processor receives multimedia data from the external electronic devices.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 shows a block diagram of a multimedia player, according to an embodiment of the invention, and an exemplary external electronic device;

FIG. 2 shows a block diagram of a multimedia player, according to an embodiment of the invention, an exemplary external electronic device, and a network to which the external electronic device is attached.

FIG. 3 shows a block diagram of a multimedia player, according to an embodiment of the invention, an exemplary external electronic device, and a network to which the external electronic device is attached.

### DETAILED DESCRIPTION OF THE INVENTION

The audio and video data, referred to as multimedia data, may be encoded in a standard media file format, such as MPEG, QuickTime, or Windows Media Format. The term “multimedia” is, however, not limited to audio and video signals. Any other signal, which can be recorded in a machine readable medium, falls within the scope of the term multimedia.

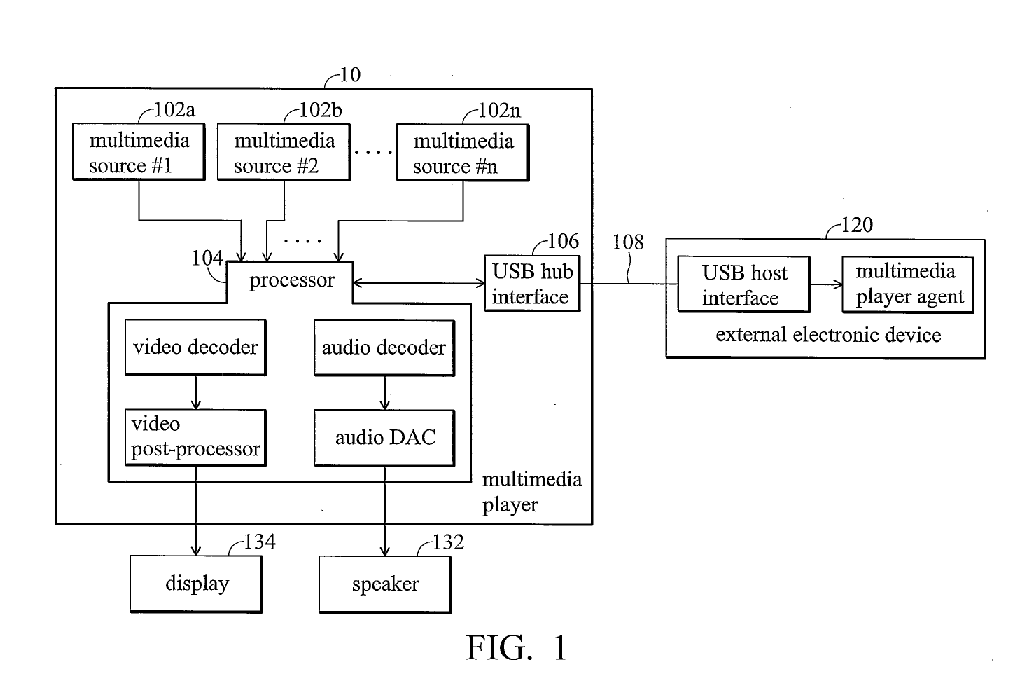

FIG. 1 shows a block diagram of a multimedia player 10 according to one embodiment of the invention. The multimedia player 10, comprising a plurality of multimedia sources 102a-102n, a processor 104, and a USB hub interface 106, can be operated in a first mode and a second mode. The multimedia sources 102a-102n are devices that provide multimedia data. For example, the multimedia sources may be optical storage devices such as CD-ROM, CD-R, or DVD drives, digital/analog television tuners, memory card reader and others. The USB hub interface 106 connects to an external electronic device 120 via a USB cable 108. The processor 104 is connected with the plurality of multimedia sources 102a-102n and the USB hub interface 106. When operated in the first mode, the multimedia player plays multimedia data (video and audio data) obtained from one of the multimedia sources. The multimedia player 10 retrieves multimedia data from one of the multimedia sources, and decodes the multimedia data. The decoded multimedia data is then ready for presentation. A display 134 and a speaker 132 can, for example, display the decoded multimedia.

When operated in the second mode, the processor connects to the external electronic device 120 via the USB hub interface 106. The plurality of multimedia sources is then able to serve as a plurality of USB devices supporting the external electronic device. To achieve this, the processor 104 may provide at least one instruction to the external electronic device 120. The external electronic device 120 interprets the instruction to recognize the plurality of multimedia sources 102a-102n as supporting USB devices and acquires control of the plurality of multimedia sources. For example, one of the multimedia sources of the multimedia player 10 is a DVD player. When the multimedia player is operated in the first mode, the multimedia player serves as a DVD player capable of reading DVD disk and outputting video and audio signals for display. When the multimedia player is operated in the second mode, the multimedia player acts as a USB device supporting the external electronic device, which means, a user may access the DVD player by controlling the external electronic device if the external electronic device requests to read the DVD disk in the DVD player.

In some embodiments, the external electronic device 120 may be a USB host comprising a multimedia player agent, such as a personal computer, and others.

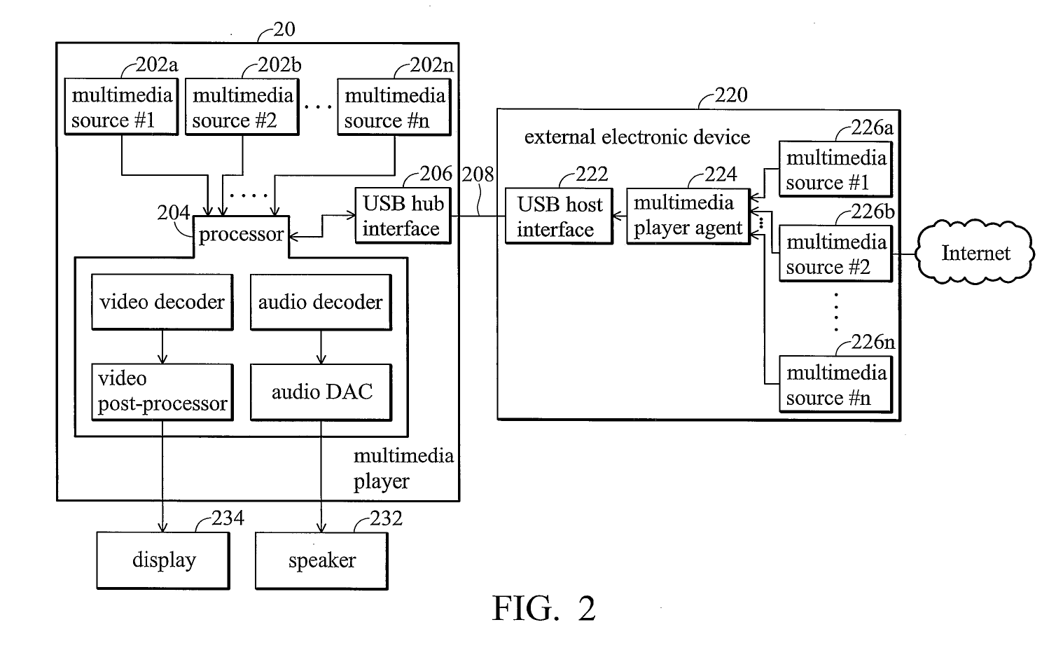

FIG. 2 shows a block diagram of a multimedia player 20 according to an embodiment of the invention. The multimedia player 20, comprising a plurality of multimedia sources 202a-202n, a processor 204, and a USB hub interface 206, can be operated in a first mode and a second mode. The multimedia player can be selectively operated in a first mode or a second mode. The plurality of multimedia sources provides multimedia data when the multimedia player operates in the first mode. For example, the multimedia sources may be optical storage devices, digital/analog television tuners, memory card readers, and others. When the multimedia player 20 operates in the first mode, the processor 204 loads multimedia data from one of the multimedia sources 202a-202n. The USB hub interface 204 connects to an external electronic device 220 via a USB cable 208. When the multimedia device operates in the second mode, the USB hub interface 206 receives multimedia data from the external electronic device. The processor 204 couples with the plurality of multimedia sources 206a-206n and the USB hub interface 206. When operated in the first mode, the processor 204 receives multimedia data from one of the multimedia sources 202a-202n and decodes the multimedia data. The decoded multimedia data is then ready for presentation; meaning, a display 234 and a speaker 232 can directly display the decoded multimedia. When operated in the second mode, the processor 204 receives multimedia data from the external electronic devices 220.

The external electronic device 220 comprises a USB host processor 222 and a multimedia player agent 224. When operated in the second mode, the processor 204 connects to the external electronic device 220 via the USB hub interface 206. The multimedia player 20 then serves as a USB device for supporting the external electronic device 220. The processor 204 sends a media request to the external electronic device 220 via the USB hub interface. The multimedia player agent 224 of the external electronic device 220 accesses multimedia sources 226a-226n for providing multimedia data to the multimedia player 20. The multimedia player agent 224 transmits a requested multimedia data through the USB host interface 222.

In some embodiments, the external electronic device 220 has at least one multimedia source 226a-226n. When operated in the second mode, one of the multimedia sources 226a-226n in the external electronic device 220 transmits requested multimedia data through the multimedia player agent 224, and the processor 204 loads and decodes the multimedia data sent from the external electronic device 220. The multimedia source 226n in the external electronic device 220 may be an optical storage device, a hard drive, a memory card reader, a mini disc drive, or magnetic disk drive. In some embodiments, the multimedia source 226b in the external electronic device 220 may be a network interface, thus the external electronic device 220 can access the Internet via the network interface. The multimedia player 20 further receives and decodes the multimedia data downloaded from the Internet. The downloaded multimedia data may be in a streaming media format, thus, the multimedia player 20 can begin displaying the streamed multimedia before the multimedia data has been completely transmitted.

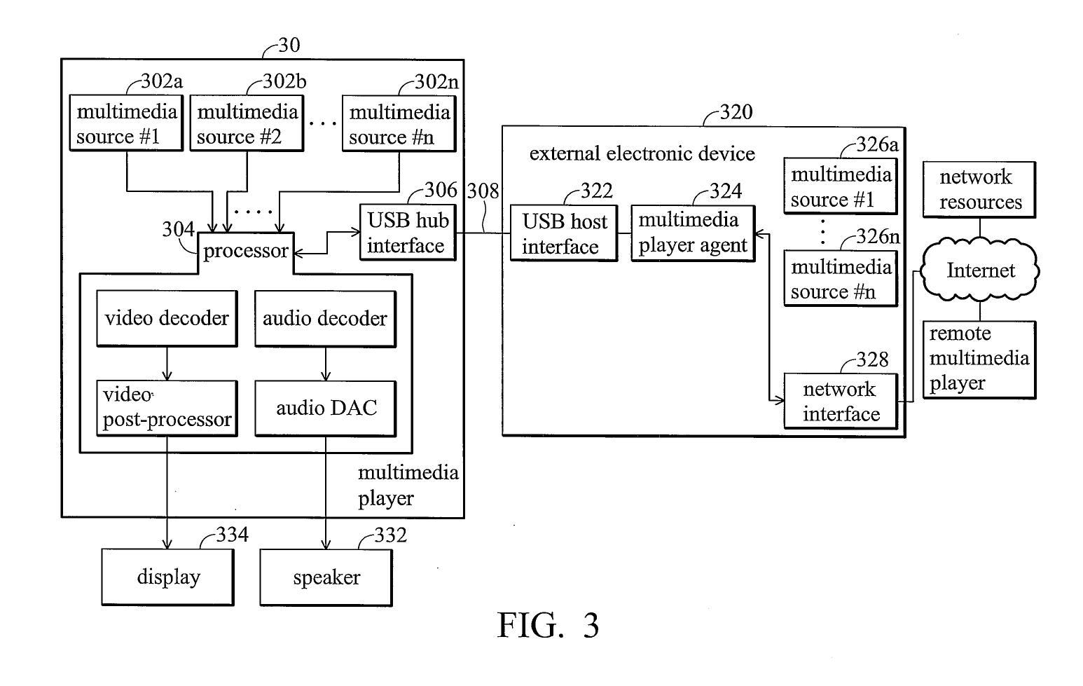

FIG. 3 shows a block diagram of a multimedia player 30 according to an embodiment of the invention. The multimedia player 30, comprising a plurality of multimedia sources 302a-302n, a processor 304, and a USB hub interface 306, can be operated in a first mode and a second mode. The multimedia sources 302a-302n are devices that provide multimedia data for display by the multimedia player. For example, the multimedia sources may be optical storage devices, digital/analog television tuners, memory card readers, and others. The USB hub interface 306 connects to an external electronic device 320 via a USB cable 308. The external electronic device 320 has a USB host processor 322 and a network interface 328. The processor 304 couples to the plurality of multimedia sources 302a-302n and the USB hub interface 306. When operated in a first mode, the processor 304 receives multimedia data from the multimedia sources 302a-302n, and decodes the multimedia data, making it ready for presentation. For example, a display 334 and a speaker 332 can directly display the decoded multimedia data. When operated in an upload mode (second mode), the processor 304 connects with and transmits multimedia data to the external electronic device 320 via the USB hub interface. The external electronic device 320 bypasses the multimedia data to a remote player through the network interface. In upload mode, multimedia data can be transferred from the local multimedia player 30 to a remote multimedia player.

The multimedia player 30 can further be operated in a download mode (third mode), and the external electronic device 320 further comprises a multimedia player agent 324. When the multimedia player operates in a third mode, the processor 304 connects to the external electronic device via the USB hub interface, sends a multimedia request to the external electronic device via the USB hub interface. Subsequent to the external electronic device interpreting the multimedia request, the multimedia player agent transmits a requested multimedia data through the USB host interface. Note that in the second mode embodiments of FIG. 2 are referred as the third mode (download mode) in the embodiment of FIG. 3.

Similarly in FIG. 2, in some embodiments, the external electronic device 320 has at least one multimedia sources 326a-326n. When operated in the third mode, the processor 304 sends a multimedia request to the external electronic device 320 via the USB hub interface 306. One of the multimedia sources 326a-326n in the external electronic device 320 transmits the requested multimedia data through the multimedia player agent, and the processor 304 receives and decodes the multimedia data sent from the external electronic device 320. The external electronic device 320 may be a computer, and the multimedia sources 326a-326n in the computer 320 may be optical storage devices, hard drives, memory card readers, mini disc drives, and or magnetic drives. The multimedia player may also play multimedia data downloaded from a network source, such as network drives; network multimedia severs, or web hyperlinks.

The USB protocol has gained near universal acceptance. The plug-and-play standard makes computer users connect peripheral devices with computers. Multimedia players with USB device and host modules are easy to connect to computers. Combining the power of computers and the proposed multimedia player offers an effective and affordable platform for building a home media center.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multimedia player for selectively operating in a first mode or a second mode, comprising:
a plurality of multimedia sources for providing multimedia data;
a USB hub interface connecting to an external electronic device and communicating with the external electronic device when the multimedia player operates in the second mode; and
a processor coupling to the plurality of multimedia sources and the USB hub interface, retrieving the multimedia data from one of the plurality of multimedia sources and decoding the multimedia data when operated in a first mode, wherein the decoded multimedia data is ready for presentation; when operated in the second mode, the processor connects to the external electronic device via the USB hub interface, the plurality of multimedia sources then act as USB devices supporting the external electronic device.

2. The multimedia player as claimed in claim 1, wherein the external electronic device is a conventional general-purpose computer, a special-purpose computer, an Internet appliance, or similar device.

3. The multimedia player as claimed in claim 1, wherein the external electronic device is a USB host comprises a multimedia player agent.

4. The multimedia player as claimed in claim 1, wherein one of the multimedia sources is an optical storage device.

5. The multimedia player as claimed in claim 1, wherein one of the multimedia sources is a memory card reader, a hard drive, a digital television tuner or an analog television tuner.

6. The multimedia player as claimed in claim 1, wherein when operated in the second mode, the processor sends at least a instruction to the external electronic device, the external electronic device interprets the instruction to recognize the plurality of multimedia sources as supporting USB devices and acquires control of the plurality of multimedia sources.

7. A multimedia player for selectively operating in a first mode or a second mode, comprising:
a plurality of multimedia sources for providing multimedia data;
a USB hub interface connecting to an external electronic device and communicating with the external electronic device when the multimedia player operates in the second mode, wherein the external electronic device comprises a USB host interface and a multimedia player agent; and
a processor coupling to the plurality of multimedia sources and the USB hub interface, receiving multimedia data and decoding the multimedia data, wherein the decoded multimedia data is ready for presentation; when operated in the first mode, the multimedia data is retrieved from one of the multimedia sources, and when operated in the second mode, the multimedia data is retrieved from the external electronic device;
wherein when operated in the second mode, the processor connects to the external electronic device via the USB hub interface, sends a multimedia request to the external electronic device via the USB hub interface; after the external electronic device interprets the multimedia request, the multimedia player agent transmits a requested multimedia data through the USB host interface.

8. The multimedia player as claimed in claim 7, wherein the external electronic device has at least one multimedia source, and when operated in the second mode, one of the multimedia sources in the external electronic device transmits the requested multimedia data through the multimedia player agent, and the processor receives and decodes the multimedia data sent from the external electronic device.

9. The multimedia player as claimed in claim 8, wherein the external electronic device is a computer, and the multimedia sources in the computer are optical storage device, hard drive, memory card reader, mini disc, and or magnetic drives.

10. The multimedia player as claimed in claim 8, wherein the external electronic device has a network interface, and the external electronic device links to one or more network sources via a network.

11. The multimedia player as claimed in claim 10, wherein the network sources are network drives, network multimedia severs, or web hyperlinks.

12. A multimedia player for selectively operating in a first mode or a second mode, comprising:
a plurality of multimedia sources for providing multimedia data;
a USB hub interface connecting to an external electronic device and communicating with the external electronic device when the multimedia player operates in the second mode, wherein the external electronic device comprises a USB host interface and a network interface; and
a processor coupling to the plurality of multimedia sources and the USB hub interface, receiving multimedia data and decoding the multimedia data, wherein the decoded multimedia data is ready for presentation;
when operated in the first mode, the multimedia data is retrieved from one of the multimedia sources, and when operated in the second mode, the processor connects to the external electronic device via the USB hub interface and, transmits multimedia data to the external electronic device, and the external electronic device bypasses the multimedia data to a remote player through the network interface.

13. The multimedia player as claimed in claim 12, wherein the multimedia player can be further operated in a third mode, and the external electronic device further comprises a multimedia player agent; when the multimedia player operates in a third mode, the processor connects to the external electronic device via the USB hub interface, sends a multimedia request to the external electronic device via the USB hub interface; after the external electronic device interprets the multimedia request, the multimedia player agent transmits a requested multimedia data through the USB host interface.

14. The multimedia player as claimed in claim 13, wherein the external electronic device has at least one multimedia source, and when operated in the third mode, one of the multimedia sources in the external electronic device transmits the requested multimedia data through the multimedia player agent, and the processor receives and decodes the multimedia data sent from the external electronic device.

15. The multimedia player as claimed in claim 13, wherein the external electronic device is a computer, and the multimedia sources in the computer are optical storage device, hard drive, memory card reader, mini disc, and or magnetic drives.

16. The multimedia player as claimed in claim 15, wherein the external electronic device has a network interface, and the external electronic device links to one or more network sources from the internet.

17. The multimedia player as claimed in claim 16, wherein the network sources are network drives, network multimedia severs, or web hyperlinks.
